(19) United States
(12) Patent Application Publication
(10) Pub. No.: US 2024/0323855 A1
(43) Pub. Date: Sep. 26, 2024

(54) APPARATUS FOR SAVING POWER IN A WIRELESS COMMUNICATION SYSTEM AND METHOD OF OPERATING THE SAME

(71) Applicant: SAMSUNG ELECTRONICS CO., LTD., Suwon-si (KR)

(72) Inventors: Hochoong CHO, Suwon-si (KR); Byungseung Kim, Suwon-si (KR); Jonghan Kim, Suwon-si (KR); Seyong Park, Suwon-si (KR)

(73) Assignee: SAMSUNG ELECTRONICS CO., LTD., Suwon-si (KR)

(21) Appl. No.: 18/611,267

(22) Filed: Mar. 20, 2024

(30) Foreign Application Priority Data
Mar. 21, 2023 (KR) 10-2023-0036891
Jul. 10, 2023 (KR) 10-2023-0089045

(51) Int. Cl. H04W 52/02; H04W 64/00

(52) U.S. Cl. CPC H04W 52/0261; H04W 64/003

(57) ABSTRACT

An application processor (AP) is operatively connected to a modem. The AP is configured to execute at least one instruction to: acquire location information of the AP; identify, based on the location information of the AP, whether the AP is located within a target area; generate a first control signal for functions being executed by the modem after identifying that the AP is located within the target area; and transmit the first control signal to the modem.

### CROSS-REFERENCE TO RELATED APPLICATION

This application is based on and claims priority under 35 U.S.C. § 119 to Korean Patent Application Nos. 10-2023-0036891, filed on Mar. 21, 2023, and 10-2023-0089045, filed on Jul. 10, 2023 in the Korean Intellectual Property Office, the disclosure of which are incorporated by reference herein in their entirety.

### BACKGROUND

### 1. Field

The disclosure relates to an application processor for power saving in a wireless communication system and an electronic apparatus including the application processor, and a method of operating the application processor and the electronic apparatus including the application processor.

### 2. Description of the Related Art

In a wireless communication system in which base stations including a plurality of (mobile communication) cells exist, an electronic apparatus (e.g., user equipment) may perform various communication functions (e.g., cell search function, cell reselection function, etc.) to access at least one cell controlled by each base station during an initial access process or handover process to a wireless network. An electronic apparatus may perform functions for measuring communication performances (e.g., an intensity of received signal, etc.) of neighboring cells and perform high-quality communication with the base station or an external apparatus in the wireless communication system.

However, in a state that an electronic apparatus does not change its location for a certain period of time, or in a situation that search/measure for neighboring cells of the electronic apparatus is impossible or unnecessary (e.g., in a situation that the electronic apparatus is moving or in an out of service state), the electronic apparatus performs functions for accessing a wireless network or functions for measuring performance of neighboring cells, and thus, which would result in unnecessary power consumption.

### SUMMARY

Provided are a method and an electronic apparatus capable of adaptively controlling functions performed in a communication module (e.g., a modem) of the electronic apparatus based on location information of the electronic apparatus (or an application processor (AP)) and/or state information of the electronic apparatus in order to provide a device without performing a function for mechanical access to a wireless network or functions for measuring performances of neighboring cells.

The technical problems of the disclosure are not limited to the technical problems mentioned above, and other technical problems not mentioned will be clearly understood by those skilled in the art from the description below.

According to an aspect of the disclosure, an application processor (AP) is operatively connected to a modem. The AP is configured to execute at least one instruction to: acquire location information of the AP; identify, based on the location information of the AP, whether the AP is located within a target area; generate a first control signal for functions being executed by the modem after identifying that the AP is located within the target area; and transmit the first control signal to the modem.

According to an aspect of the disclosure, a modem operatively connected to an application processor (AP), wherein the modem is configured to: receive, from the AP, at least one control signal among a first control signal, a second control signal, and a third control signal for functions being executed by the modem; change settings of a target module of the modem corresponding to the at least one control signal; and transmit a setting completion signal of the target module to the AP, and wherein the first control signal is received in a first case that the AP is located within a target area, wherein the second control signal is received in a second case that the AP is moving, and wherein the third control signal is received in a third case that the communication state of the modem is an out of service state.

According to an aspect of the disclosure, an electronic apparatus includes: a control module; and a communication module. The control module is configured to: acquires location information and state information of the electronic apparatus, generate a control signal for functions being executed by the communication module based on at least one of the location information of the electronic apparatus and the state information of the electronic apparatus, and transmits the control signal to the communication module. The communication module is configured to: change the setting of a target function corresponding to the control signal based on the changed transmitted control signal, and transmit a setting completion signal of the target function to the control module.

### BRIEF DESCRIPTION OF THE DRAWINGS

Embodiments will be more clearly understood from the following detailed description taken in conjunction with the accompanying drawings in which:

FIGS. 1A and 1B illustrate a wireless communication system according to an embodiment;

FIG. 2 illustrates a wireless communication apparatus according to an embodiment;

FIG. 3 illustrates a method of setting control items for functions of a communication module according to an embodiment;

FIG. 4 illustrates a method of setting control items for functions of a communication module according to an embodiment;

FIG. 5 illustrates a method of setting control items for functions of a communication module according to an embodiment;

FIG. 6 illustrates a method of setting control items for functions of a communication module according to an embodiment;

FIG. 7 illustrates an electronic device according to an embodiment; and

FIG. 8 illustrates communication devices including a plurality of antenna modules according to an embodiment.

### DETAILED DESCRIPTION

Hereinafter, embodiments of the disclosure are described in detail with reference to the accompanying drawings.

The disclosure partially uses terms and names defined in the 3rd generation partnership project long term evolution (3GPP LTE) standard or new radio (NR) standard. However, the disclosure is not limited by the terms and names and may be equally applied to systems conforming to other standards.

A base station (BS) according to an embodiment may refer to a fixed station that communicates with a terminal and/or another base station. For example, a base station may be referred to as a Node B, an evolved-Node B (eNB), a sector, a site, a base transceiver system (BTS), an access point, a relay node, a remote radio head (RRH), a radio unit (RU), and the like. For example, in a wireless communication system, a base station is a minimum unit of an area for providing a communication service for each base station and includes at least one cell. A base station may provide efficient multi-access communication for a plurality of terminals based on specific frequency resources allocated to each cell. In particular, in the case of a multiple-input and multiple-output (MIMO) system, a terminal and a base station may perform wireless communication therebetween based on a plurality of component carriers.

A terminal according to an embodiment may be referred to as, for example, user equipment, a mobile station (MS), a mobile terminal (MT), a subscribe station (SS), a wireless device, a handheld device, and the like.

A wireless communication system according to an embodiment may include, as non-limiting examples, an NR system, a 5th generation (5G) system, a long term evolution (LTE) system, a code division multiple access (CDMA) system, a global system for mobile communications (GSM) system, a wireless local area network (WLAN) system, or any arbitrary wireless communication system. Hereinafter, the wireless communication system will be described on the premise that the wireless communication system is an NR system, an LTE system, or a system capable of supporting NR and LTE-based communication, but it will be understood that the technical spirit of the disclosure is not limited thereto.

A terminal according to an embodiment may support 4G communication (e.g., LTE, LTE-advanced (LTE-A)), 5G communication (e.g., NR) and the like specified in the 3rd generation partnership project (3GPP) standard.

For example, terminals of the 4G communication and 5G communication may support a communication protocol based on CDMA, a communication protocol based on wideband CDMA (WCDMA), a communication protocol based on time division multiple access (TDMA), a communication protocol based on a frequency division multiple access (FDMA), a communication protocol based on orthogonal frequency division multiplexing (OFDM), a communication protocol based on cyclic prefix (CP)-OFDM, a communication protocol based on discrete Fourier transform-spread-OFDM (DFT-s-OFDM), a communication protocol based on non-orthogonal Multiple Access (NOMA), a communication protocol based on generalized frequency division multiplexing (GFDM), and the like.

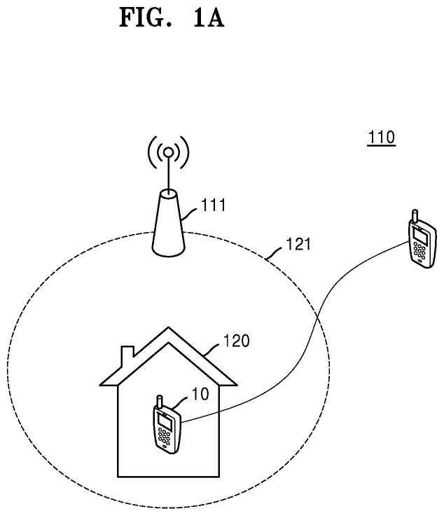

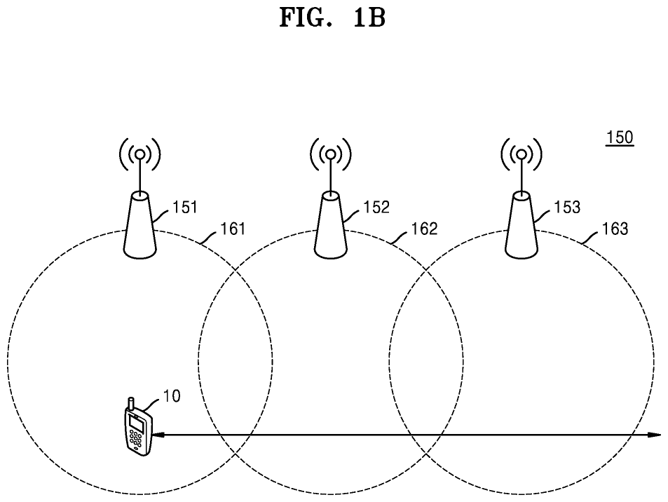

FIGS. 1A and 1B show an example of a wireless communication system 110 according to an embodiment.

Referring to FIG. 1A, the wireless communication system 110 may include a base station (BS) 111 including a cell 121 for providing a wireless communication service and user equipment (UE) (or a terminal) 10. In FIG. 1A, a state is assumed in which the terminal 10 includes an application processor (AP) and enters a target area 120 from an external area.

The cell 121 of the base station 111 may denote a cell corresponding to a location of the target area 120 among a plurality of cells managed by the base station 111. The target area 120 may be determined by a user based on a location pre-registered. For example, the target area 120 is a location where the location of the terminal 10 does not change for a certain period of time or more and may include a user's home or office. When the terminal 10 enters the target area 120, as the location of the terminal 10 does not change for more than a certain period of time, in order to prevent unnecessary power consumption of the terminal 10, it is necessary to deactivate or partially limit communication functions, such as an additional cell search function or a cell measurement function.

According to an embodiment, when the terminal 10 is located within the target area 120, power loss due to the execution of unnecessary functions may be prevented by changing settings of control items for a function being executed by a communication module of the terminal 10 based on the location information of the terminal 10, and thus, it is possible to provide a terminal device in which energy efficiency is maximized and a method of operating the terminal device.

Referring to FIG. 1B, a wireless communication system 150 may include base stations (BSs) (e.g., a first base station 151 controlling a first cell 161, a second base station 152 controlling a second cell 162, and a third base station 153 controlling a third cell 163) for providing a wireless communication service while the terminal 10 is moving and the terminal 10. In FIG. 1B, a state is assumed in which the terminal 10 is moving through the first cell 161 to the third cell 163.

As shown in FIG. 1B, when the terminal 10 is moving, as the position of the terminal 10 continuously changes within a predetermined time, in order to prevent unnecessary power consumption, it is necessary to deactivate or partially limit communication functions such as an additional cell search or a cell measurement.

According to an embodiment, when the terminal 10 is moving, it is possible to provide a terminal device that may adaptively change settings of control items for functions being executed by a communication module of the terminal 10 considering the situation in which the terminal 10 is moving and a method of operating the terminal device.

In an embodiment, even when the communication state of the terminal 10 is in an out of service state, that is, even when there is no cell available for connection in the vicinity, in order to prevent unnecessary power consumption, it is necessary to deactivate or partially limit communication functions such as an additional cell search function or a cell measurement function.

According to an embodiment, when the communication state of the terminal 10 is in an out of service state, it is possible to provide a terminal device that may adaptively change settings of control items for functions being executed by the communication module of the terminal 10 considering an out of service state of the terminal 10 and a method of operating the terminal device.

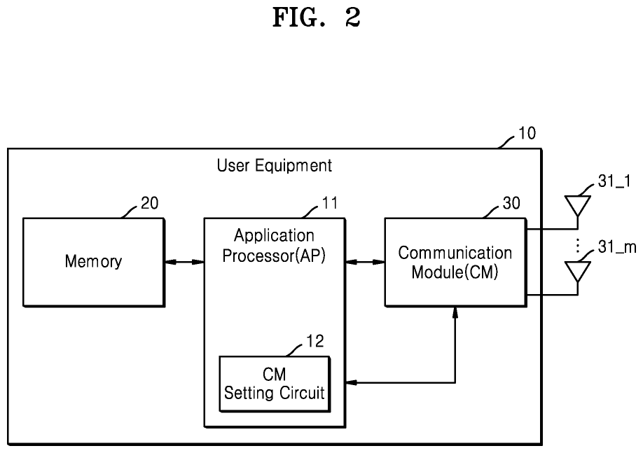

FIG. 2 is a block diagram illustrating a wireless communication device according to an embodiment.

Referring to FIG. 2, the wireless communication device (a terminal, user equipment) 10 includes an application processor (AP) 11, a memory 20, a communication module (CM) (e.g., a modem) 30, a CM setting circuit 12, and a plurality of antennas (e.g., a first antenna 31_1 to an m^{th} antenna 31_m).

The CM 30 of the terminal 10 may transmit RF signals to a base station through a serving cell using the plurality of antennas (e.g., the first antenna 31_1 to the m^{th} antenna 31_m). The CM 30 may down-convert RF signals received from the base station to generate intermediate frequency or baseband signals. The AP 11 may generate data signals by filtering, decoding, and/or digitizing an intermediate frequency or baseband signals. The AP 11 may additionally process data signals transmitted and received to and from the base station.

Also, the CM 30 may receive data signals from the AP 11. The CM 30 may encode, multiplex and/or analog-convert the received data signals. The CM 30 may frequency up-convert the intermediate frequency or baseband signals output from the AP 11 and transmit the RF signals to the base station through the first antenna 31_1 to the m^{th} antenna 31_m.

The memory 20 may include an operating system and an application including device drivers, executable libraries, and/or program code and/or process registers. The operating system and application may be implemented by executing code and/or instructions by a processor as software elements. For example, based on location information according to embodiments, when the terminal 10 (or the AP 11) is located in a target area (e.g., a user's home or a user's office), when the terminal 10 (or the AP 11) is moving, or when the terminal 10 (or CM 30) is in an out of service state, the memory 20 may store a setting value set of at least one control item as a program code executed for performing an operation (that is, an operation of generating control signals for functions being executed by the CM 30 in each case) for changing setting values of at least one control item for functions being executed by the CM 30. The program code may be stored such that a setting value set of at least one control item that is changed when the terminal 10 (or the AP 11) is located in the target area is categorized as a first set value set, a setting value set of at least one control item that is changed when the terminal 10 (or the AP 11) is moving is categorized as a second set value set, and a setting value set of at least one control item that is changed when the terminal 10 (or the CM 30) is in an out of service state is categorized as a third set value set.

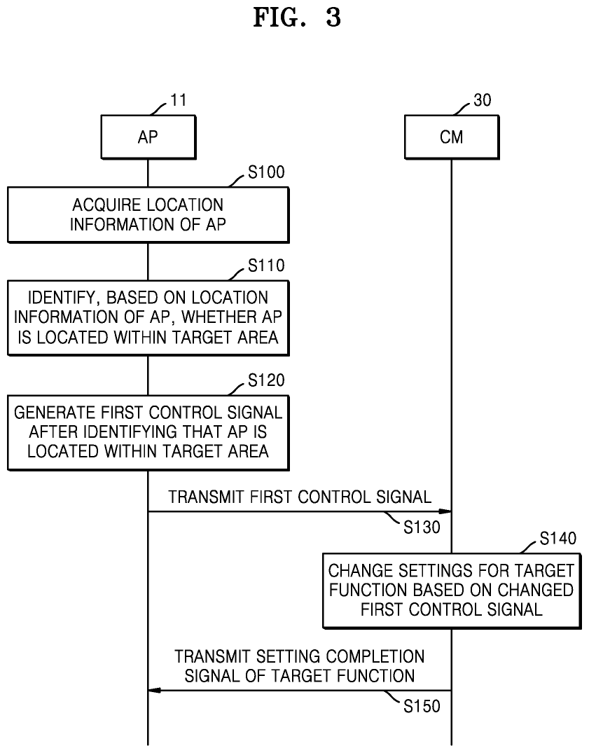

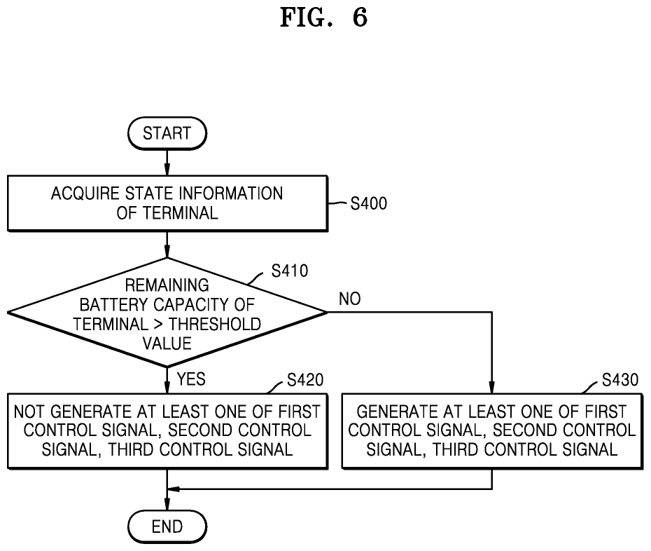

The CM setting circuit 12 of the AP 11 according to an embodiment may be implemented as a logic block implemented through logic synthesis, a software block executed by a processor, or a combination thereof. In one embodiment, the CM setting circuit 12 may be a procedure as a set of a plurality of instructions executed by the processor and may be stored in a memory accessible by the processor. The CM setting circuit 12, based on the location information of the terminal 10 (or the AP 11), may identify whether the location of the terminal 10 (or the AP 11) is within a target area or the terminal 10 (or the AP 11) is in a moving state or in an out of service state. According to the identified location of the terminal 10 or the situation/state of the terminal 10, the CM setting circuit 12 may generate a control signal for changing a setting value of at least one control item for functions being executed by the CM 30, as described with reference to FIGS. 3 to 5 below. The CM setting circuit 12 may determine whether or not to transmit, to the CM 30, a control signal for changing a set value of at least one control item for functions being executed by the CM 30 according to the remaining battery capacity of the terminal 10, as described with reference to FIG. 6 below. The AP 11 (or the CM setting circuit 12) may transmit a control signal including a set value of at least one changed control item to the CM 30.

The CM 30 according to an embodiment may receive the control signal including a set value of at least one changed control item from the AP 11 (or the CM setting circuit 12), and, based on the received control signal, may change the setting of control items for a target function corresponding to the at least one control item. When the setting of the control item for the target function is completed, the CM 30 may transmit a setting completion signal indicating that the setting of the target function is completed to the AP 11.

The AP 11 may control the terminal 10 for wireless network-based communication.

In one embodiment, the AP 11 may execute a program and/or process stored in the memory 20 to perform an overall control operation for the terminal 10. In some embodiments, based on the location information of the terminal 10 according to embodiments, when the terminal 10 is located in a target area, when the terminal 10 is moving, or when the terminal 10 is in an out of service state, the setting value set of at least one control item may be stored in the memory 20 as program code to be executed for performing an operation (that is, an operation of generating control signals for functions being executed by the CM 30) of changing the setting value of at least one control item for functions being executed by the CM 30, and the AP 11 may generate a control signal to change the setting value of at least one control item for the functions being executed by the CM 30 by accessing the memory 20 to execute the stored program code, and thus, may adaptively control some functions of the CM 30 according to the location of the terminal 10, the situation of the terminal 10, and/or an internal state of the terminal 10 (e.g. the remaining battery capacity of the terminal 10) in a state that the CM 30 is being activated.

The terminal 10 (e.g., the AP 11) according to an embodiment, based on the location information of the terminal 10 which is described with reference to FIGS. 3 to 6 below, as settings for functions being executed by the CM 30 are adaptively changed according to location/circumstances of the terminal 10, it is possible to prevent waste of power consumption due to execution of unnecessary functions.

FIG. 3 is a flowchart illustrating a method of setting control items for functions of a communication module according to an embodiment.

Specifically, with respect to FIG. 3, when the terminal 10 (or the AP 11) is located within a target area, a method of controlling a function being executed by the CM 30 by the AP 11, according to an embodiment, is described from the viewpoint of each device. The AP 11 and the CM 30 of FIGS. 3 to 6 may correspond to the AP 11 and the CM 30 of FIG. 2 described above.

Referring to FIG. 3, when the terminal 10 (or the AP 11) is located within a target area, a control method for the function being executed by the CM 30 may include operations S100 to S150. Here, a function being executed by the CM 30 may be controlled by changing a setting value of a control item for a function being executed by the CM 30 based on a first control signal received from the AP 11.

In operation S100, the AP 11 may acquire location information of the AP 11. Here, the location information of the AP 11 may denote location information of the terminal 10. For example, the AP 11 may receive location information of the AP 11 from a positioning system of the terminal 10. The positioning system may include at least one of a global positioning system (GPS), a Wi-Fi positioning system (WPS), and a cellular positioning system (CPS). The location information of the AP 11 may include GPS information, CPS information, or WPS information.

In operation S110, the AP 11 may identify whether the AP 11 is located within a target area. For example, the AP 11 may identify whether the AP 11 is located within a target area based on the location information of the AP 11. Here, the target area may be a location pre-registered by a user and may denote a location where the location of the AP 11 does not change for a certain period of time or more. For example, the target area may be an area including a user's home or office previously registered by the user.

In operation S120, the AP 11 may generate a first control signal when (after identifying that) the AP 11 is located within a target area. Here, the first control signal may denote a control signal for target functions that are changed in the CM 30 when the AP 11 is located in the target area. For example, the first control signal may include a control signal for at least one of an on/off item for a measurement function of a neighboring cell in the same radio access technology (RAT) as a RAT of the terminal 10 (e.g., a RAT accessed by the modem 30), items of a measurement period and the number of measurements for a measurement function of a neighboring cell in the same RAT, an on/off item for a measurement function of a neighboring cell of a RAT different from the RAT of the terminal 10 (e.g., the RAT accessed by the modem 30), items of the measurement period and the number of measurements for a measurement function of a neighboring cell of another RAT, an on/off item for a cell handover function, an on/off item for a cell reselection function, an item for a decoding cycle for paging, an item for controlling transmission power of a signal, an item for controlling a feedback value of a physical channel, and an item for controlling a signal reception mode (e.g., the number of antenna modules used in a reception mode, etc.). For example, when the AP 11 is located within a target area, the AP 11 may generate a control signal to turn off a measurement function of a neighboring cell in the same RAT, or to change a set value of a corresponding control item so that the measurement period and number of measurements for measurement functions of the neighboring cell in the same RAT are reduced. For example, when the AP 11 is located within a target area, the AP 11 may turn-off a cell handover function of the CM 30 and generate a control signal to turn off a cell reselection function of the CM 30.

In operation S130, the AP 11 may transmit a first control signal to the CM 30.

In operation S140, the CM 30 may change settings for a target function based on the first control signal. In an embodiment, the CM 30 may change set values of control items for target functions corresponding to the first control signal received from the AP 11. In an embodiment, the CM 30 may turn off a measurement function of a neighboring cell in the same RAT by changing a setting value of a control item for the measurement function of the neighboring cell in the same RAT based on the first control signal received from the AP 11. In an embodiment, the CM 30 may extend the measurement period and reduce the number of measurements for the measurement function of the neighboring cell in the same RAT by changing the setting value of a control item for the measurement function of a neighboring cell in the same RAT based on the first control signal received from the AP 11. In an embodiment, the CM 30 may turn-off a cell handover function and a cell reselection function by changing a setting value of the control item for the cell handover function and the cell reselection function based on the first control signal received from the AP 11.

In operation S150, the CM 30 may transmit a setting completion signal of the target function to the AP 11. For example, the CM 30 may transmit the setting completion signal of the target function to the AP 11 after completing the change of a setting value for a control item of the target function based on a first control signal received from the AP 11.

In the terminal 10 (or the AP 11) according to an embodiment, when the terminal 10 (or the AP 11) is located within a target area, there is a technical effect of preventing unnecessary power consumption by adaptively changing a setting value of the control item for the function of the CM 30 based on a first control signal.

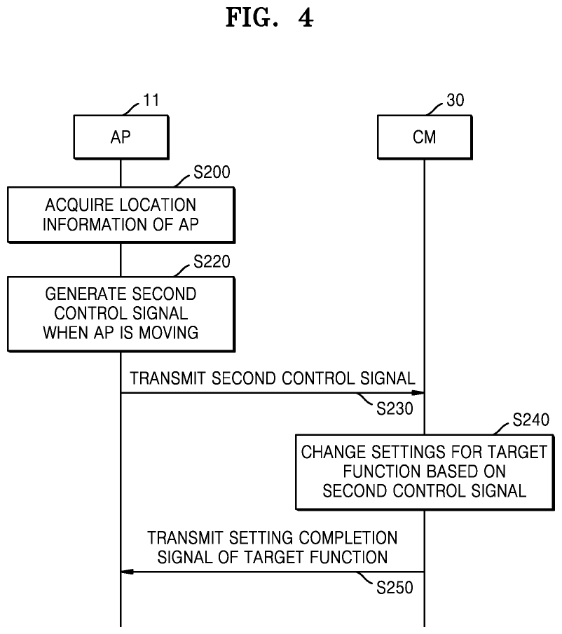

FIG. 4 is a flowchart illustrating a method of setting control items for functions of a communication module according to an embodiment.

Specifically, with respect to FIG. 4, when the AP 11 is moving, a method of controlling a function being executed by the CM 30, according to an embodiment is described from the viewpoint of each device. The AP 11 and the CM 30 of FIGS. 3 to 6 may correspond to the AP 11 and the CM 30 of FIG. 2 described above. FIG. 3 is also referred, and among operations of FIG. 4, the operations that are substantially the same as the operations of FIG. 3 are referred to in the description of FIG. 3.

Referring to FIG. 4, when the AP 11 is moving, the control method for the function being executed by the CM 30 may include operations S200 to S250. Here, the control of a function being executed by the CM 30 may be completed when a set value of a control item for a function being executed by the CM 30 is changed by the CM 30 based on a second control signal received from the AP 11.

In operation S200, the AP 11 may obtain location information of the AP 11. Here, the location information of the AP 11 may denote location information of the terminal 10. For example, the AP 11 may receive location information of the AP 11 from a positioning system of the terminal 10. The positioning system of the terminal 10 may include at least one of a GPS, a WPS, and a CPS. The location information of the AP 11 may include GPS information, CPS information, or WPS information.

In an operation, the AP 11 can identify whether the AP 11 is moving. For example, the AP 11 may identify whether the AP 11 is moving based on the location information of the AP 11 (e.g., the amount of change in location information of the AP 11 per unit time).

In operation S220, the AP 11 may generate a second control signal when (after identifying that) the AP 11 is moving. Here, the second control signal may refer to a control signal for target functions that are changed in the CM 30 when the AP 11 is moving. The second control signal may include a control signal for at least one of an on/off item for a measurement function of a neighboring cell in the same RAT as the RAT of the terminal 10 (e.g., a RAT accessed by the CM 30 items of a measurement period and the number of measurements for a measurement function of a neighboring cell in the same RAT, an on/off item for a measurement function of a neighboring cell of a RAT different from the RAT of the terminal 10 (e.g., the RAT accessed by the CM 30, and items of a measurement period and the number of measurements for a measurement function of a neighboring cell of a RAT different from the RAT of the terminal 10. For example, when the AP 11 is moving, the AP 11 may generate the second control signal for turning off a measurement function of a neighboring cell in the same RAT, for extending a measurement period for the measurement function of the neighboring cell in the same RAT, and for changing the set value of a corresponding control item to reduce the number of measurements.

In operation S230, the AP 11 may transmit the second control signal to the CM 30.

In operation S240, the CM 30 may change the settings for a target function based on the second control signal. For example, the CM 30 may change setting values of control items for target functions corresponding to the second control signal received from the AP 11. For example, the CM 30 may turn off a measurement function of a neighboring cell in the same RAT by changing a setting value of a control item for the measurement function of the neighboring cell in the same RAT based on the second control signal received from the AP 11. For example, the CM 30 may extend the measurement period for the measurement function of a neighboring cell in the same RAT and reduce the number of measurements by changing the setting value of a control item for the measurement function of the neighboring cell in the same RAT based on the second control signal received from the AP 11.

In operation S250, the CM 30 may transmit a setting completion signal of a target function to the AP 11. For example, the CM 30 may transmit a setting completion signal of the target function to the AP 11 after completing the change of the setting value for a control item of the target function based on the second control signal received from the AP 11.

In the terminal 10 (or the AP 11) according to an embodiment, when the terminal 10 (or the AP 11) is moving, there is a technical effect of preventing unnecessary power consumption by adaptively changing a setting value for a target function based on the second control signal for the function of the CM 30.

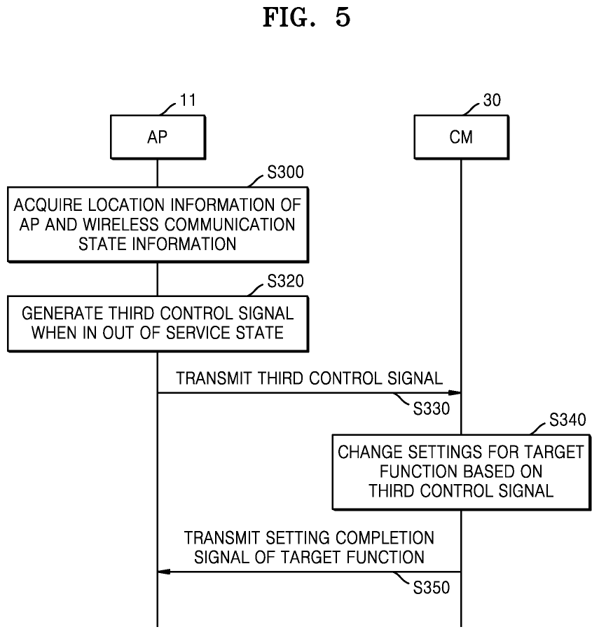

FIG. 5 is a flowchart illustrating a method of setting control items for functions of a communication module according to an embodiment.

Specifically, with respect to FIG. 5, when the terminal 10 (or the CM 30) is in an out of service state, a method of controlling a function being executed by the CM 30, according to an embodiment is described from the viewpoint of each device. The AP 11 and the CM 30 of FIGS. 3 to 6 may correspond to the AP 11 and the CM 30 of FIG. 2 described above. FIG. 3 is also referred, and among operations of FIG. 5, the descriptions of operations that are substantially the same as the operations of FIG. 3 are referred to in the description of FIG. 3.

Referring to FIG. 5, when the terminal 10 (or the CM 30) is in an out of service state, the control method for the function being executed by the CM 30 may include operations S300 to S350. Here, the control of a function being executed by the CM 30 may be completed when a set value of a control item for a function being executed by the CM 30 is changed by the CM 30 based on a third control signal received from the AP 11.

In operation S300, the AP 11 may acquire location information of the AP 11 and wireless communication state information of the terminal 10 (or the CM 30). For example, the AP 11 may receive location information of the AP 11 from a positioning system of the terminal 10. The positioning system may include at least one of a GPS, a WPS, and a CPS. The location information of the AP 11 may include GPS information, CPS information, or WPS information. The wireless communication state information of the terminal 10 (or the CM 30) may include information about a wireless network to which the terminal 10 (or the CM 30) is connected.

In an operation, the AP 11 may identify whether the communication state of the terminal 10 (or the CM 30) is in an out of service state or not. For example, the AP 11 may identify whether the terminal 10 (or the CM 30) is in an out of service state based on location information of the AP 11 and wireless communication state information of the terminal 10 (or the CM 30) (e.g., information indicating that there is no cell accessible from the current location of the terminal 10).

In operation S320, the AP 11 may generate a third control signal when (after identifying that) the terminal 10 is in an out of service state. Here, the third control signal may refer to a control signal for target functions changed in the CM 30 when the terminal 10 (or the CM 30) is in an out of service state. The third control signal may include at least one of a search period item and a search number item for a cell search function for each neighboring RAT of the terminal 10. For example, when the terminal 10 (or the CM 30) is in an out of service state, the AP 11 may extend the search period for a cell search function for each neighboring RAT and generate a control signal for changing a setting value of a corresponding control item to reduce the number of searches.

In operation S330, the AP 11 may transmit a third control signal to the CM 30.

In operation S340, the CM 30 may change settings for a target function based on the third control signal. For example, the CM 30 may change a set value of a control item for the target function corresponding to the third control signal received from the AP 11. For example, the CM 30 may extend the search period for the cell search function for each neighboring RAT and reduce the number of searches by changing the setting value of the control item for the cell search function for each neighboring RAT based on the third control signal received from the AP 11.

In operation S350, the CM 30 may transmit a setting completion signal of the target function to the AP 11. For example, the CM 30 may transmit the setting completion signal of the target function to the AP 11 after completing the change of the setting value of the control item of the target function based on the third control signal received from the AP 11.

In the terminal 10 (or the AP 11) according to an embodiment, when the terminal 10 (or the CM 30) is in an out of service state, there is a technical effect of preventing unnecessary power consumption by adaptively changing a setting for the target function based on the third control signal for the function of the CM 30.

FIG. 6 is a flowchart illustrating a method of setting control items for functions of a communication module according to an embodiment.

Specifically, FIG. 6 is an embodiment of any one of operation S120 of FIG. 3, operation S220 of FIG. 4, and operation S320 of FIG. 5, and, based on an internal state of a terminal, a method of adaptively setting control items for functions of the CM30 will be described.

Referring to FIG. 6, the method of setting control items for the function of the CM 30 considering the internal state (e.g., remaining battery capacity state) of the terminal 10 by the AP 11 may include operations S400 to S430.

In operation S400, the AP 11 may acquire state information of the terminal 10. Here, the state information of the terminal 10 may include information about the remaining battery capacity of the terminal 10.

In operation S410, the AP 11 may identify whether the remaining battery capacity of the terminal 10 is greater than a threshold value or not. The AP 11 may finally determine whether to generate at least one of the first control signal of FIG. 3, the second control signal of FIG. 4, and the third control signal of FIG. 5 based on the identification result of whether the remaining battery capacity of the terminal 10 is greater than a threshold value. Based on the state information of the terminal 10, the AP 11 may perform operation S420 when the identified remaining battery capacity of the terminal 10 is greater than a threshold value and perform operation S430 when the identified remaining battery capacity of the terminal 10 is less than the threshold value.

In one embodiment, the first control signal may denote a control signal of target functions that are changed in the CM 30 when the AP 11 is located in a target area. For example, the first control signal may include a control signal for at least one of an on/off item for a measurement function of a neighboring cell in the same RAT as the RAT of the terminal 10, an item of a measurement period and the number of measurements for a measurement function of a neighboring cell in the same RAT, an on/off item for a measurement function of a neighboring cell of a RAT different from the RAT of the terminal 10, an item of a measurement period and the number of measurements for a measurement function of a neighboring cell of another RAT, an on/off item for a cell handover function, an on/off item for a cell reselection function, an item for a decoding period of paging, an item for controlling signal transmission power, an item for controlling a feedback value of a physical channel, and an item for controlling a signal reception mode.

In one embodiment, the second control signal may denote a control signal for target functions that are changed in the CM 30 when the AP 11 is moving. For example, the second control signal may include a control signal for at least one of an on/off item for a measurement function of a neighboring cell in the same RAT as the RAT of the terminal 10, items of a measurement period and the number of measurements for a measurement function of a neighboring cell in the same RAT, an on/off item for a measurement function of a neighboring cell of a RAT different from the RAT of the terminal 10, and items of a measurement period and the number of measurements for a measurement function of a neighboring cell of a RAT different from the RAT of the terminal 10.

In one embodiment, the third control signal may denote a control signal for target functions changed in the CM 30 when the terminal 10 (or the CM 30) is in an out of service state. For example, the third control signal may include a control signal for at least one of a search period item and a search number item for a cell search function for each neighboring RAT of the terminal 10.

In operation S420, the AP 11 may not generate at least one control signal of the first control signal, the second control signal, and the third control signal when it is identified that the remaining battery capacity of the terminal 10 is greater than or equal to a threshold value. For example, referring to FIGS. 3 and 6, when the AP 11 is identified as being located within a target area and the remaining battery capacity of the terminal 10 is greater than or equal to a threshold value, the AP 11 may not generate a first control signal for functions executed by the CM 30. For example, referring to FIGS. 4 and 6, when the AP 11 is moving and the remaining battery capacity of the terminal 10 is greater than or equal to a threshold value, the AP 11 may not generate a second control signal for functions executed by the CM 30. For example, referring to FIGS. 5 and 6, when the terminal 10 (or the CM 30) is in an out of service state and the remaining battery capacity of the terminal 10 is greater than or equal to a threshold value, the AP 11 may not generate a third control signal for functions executed by the CM 30.

In operation S430, the AP 11 may generate at least one control signal of the first control signal, the second control signal, and the third control signal when it is identified that the remaining battery capacity of the terminal 10 is less than a threshold value. For example, referring to FIGS. 3 and 6, when the AP 11 is identified as being located within a target area and the remaining battery capacity of the terminal 10 is less than a threshold value, the AP 11 may generate a first control signal for functions executed by the CM 30. For example, referring to FIGS. 4 and 6, when the AP 11 is moving and the remaining battery capacity of the terminal 10 is less than a threshold value, the AP 11 may generate a second control signal for functions executed by the CM 30. For example, referring to FIGS. 5 and 6, when the terminal 10 (or the CM 30) is in an out of service state and the remaining battery capacity of the terminal 10 is less than a threshold value, the AP 11 may generate a third control signal for functions executed by the CM 30.

The terminal 10 (e.g., the AP 11) according to an embodiment may perform adaptive control for functions executed by the CM 30 considering not only the location or situation of the terminal 10 (or the AP 11) described with reference to FIGS. 3 to 5 but also an internal state of the terminal 10 (e.g., the state of the remaining battery capacity of the terminal 10).

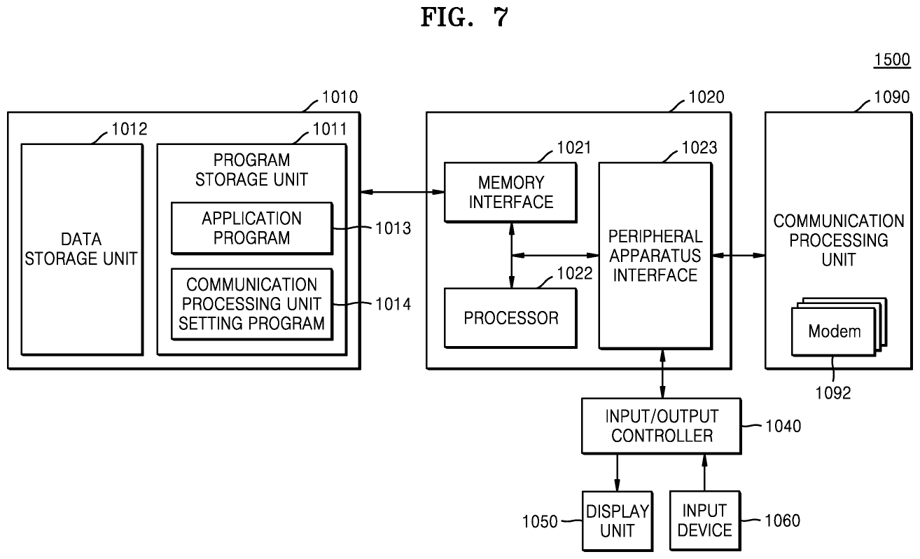

FIG. 7 is a block diagram illustrating an electronic apparatus 1500 according to an embodiment. The electronic apparatus 1500 of FIG. 7 may correspond to the terminal 10 of FIG. 1.

Referring to FIG. 7, the electronic apparatus 1500 may include a memory 1010, a processor unit 1020, an input/output controller 1040, a display unit 1050, an input device 1060, and a communication processing unit 1090. Here, a plurality of memories 1010 may exist. Here, each component will be described.

The memory 1010 may include a program storage unit 1011 configured to store a program for controlling an operation of the electronic apparatus 1500 and a data storage unit 1012 configured to store data generated during program execution. The data storage unit 1012 may store data necessary for the operation of an application program 1013 and a communication processing unit setting program 1014. The program storage unit 1011 may include the application program 1013 and the communication processing unit setting program 1014. Here, a program included in the program storage unit 1011 may be expressed as an instruction set as a set of instructions.

The application program 1013 includes an application program that operates in an electronic apparatus. That is, the application program 1013 may include instructions of an application driven by a processor 1022. According to embodiments, the communication processing unit setting program 1014 may adaptively control functions of the communication processing unit 1090 according to the location or situation of an electronic apparatus based on location information of the electronic apparatus. For example, when an electronic apparatus is located within a target area, when the electronic apparatus is moving, or when the electronic apparatus is in an out of service state, the communication processing unit setting program 1014 may adaptively change setting values of control items for functions being executed by a modem 1092 of the communication processing unit 1090.

A peripheral apparatus interface 1023 may control a connection between an I/O peripheral apparatus of a base station and the processor 1022 and a memory interface 1021. The processor 1022 controls the base station to provide a corresponding service using at least one software program. In this case, the processor 1022 may provide a service corresponding to the corresponding program by executing at least one program stored in the memory 1010.

The input/output controller 1040 may provide an interface between an input/output apparatus such as the display unit 1050 and the input device 1060 and the peripheral apparatus interface 1023. The display unit 1050 displays status information, input text, a moving picture, a still picture, and the like. For example, the display unit 1050 may display application program information driven by the processor 1022.

The input device 1060 may provide input data generated by selection of an electronic apparatus to the processor unit 1020 through the input/output controller 1040. In this case, the input device 1060 may include a keypad including at least one hardware button and a touch pad that detects touch information. For example, the input device 1060 may provide touch information, such as a touch detected through a touch pad, a touch movement, or a touch release, to the processor 1022 through the input/output controller 1040. The electronic apparatus 1500 may include the communication processing unit 1090 that performs communication functions for voice communication and data communication. According to embodiments, the communication processing unit 1090 may include the modem 1092 that performs various functions (e.g., a cell search function, a cell measurement function, a handover function, etc.) for performing various wireless communications by accessing a wireless network.

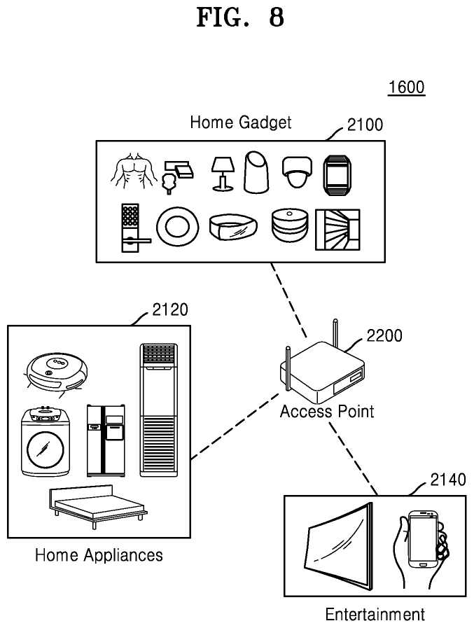

FIG. 8 is a diagram illustrating communication devices 1600 including a plurality of antenna modules according to an embodiment.

Referring to FIG. 8, in a device control module or processor of a household device 2100, a home appliance 2120, and an entertainment device 2140, a controller of a device according to embodiments may perform an operation of adaptively setting a control item for a function of a communication module in each device based on the location of the device or the situation/state of the device. In some embodiments, the household device 2100, the home appliance 2120, the entertainment device 2140, and an access point 2200 may constitute an Internet of Things (IoT) network system. It will be understood that the communication devices shown in FIG. 8 are only examples, and the embodiments according to the disclosure may be applied to other communication devices.

While the disclosure has been particularly shown and described with reference to embodiments thereof, it will be understood that various changes in form and details may be made therein without departing from the spirit and scope of the following claims.

What is claimed is:

1. An application processor (AP) operatively connected to a modem, wherein the AP is configured to execute at least one instruction to:
acquire location information of the AP;
identify, based on the location information of the AP, whether the AP is located within a target area;
generate a first control signal for functions being executed by the modem after identifying that the AP is located within the target area; and
transmit the first control signal to the modem.

2. The AP of claim 1, wherein the first control signal comprises a control signal for at least one of:
an on/off item for a measurement function of a neighboring cell in a same radio access technology (RAT) as a RAT connected by the modem,
an item of a measurement period and a number of measurements for the measurement function of the neighboring cell in the same RAT,
an on/off item for a measurement function of a neighboring cell in another RAT than the RAT connected by the modem,
an item of a measurement period and the number of measurements for the measurement function of the neighboring cell in the another RAT,
an on/off item for a cell handover function,
an on/off item for a reselection function, an item for a decoding period of paging,
an item for controlling signal transmission power,
an item for controlling a feedback value of physical channels, and
an item for controlling a signal reception mode.

3. The AP of claim 1, wherein the AP is further configured to execute the at least one instruction to:
generate a second control signal for functions being executed by the modem after identifying, based on the location information of the AP, that the AP is moving; and
transmit the second control signal to the modem.

4. The AP of claim 3, wherein the second control signal comprises:
a control signal for at least one of an on/off item for a measurement function of a neighboring cell in a same RAT as a RAT accessed by the modem,
an item of a measurement period and a number of measurements for the measurement function of the neighboring cell in the same RAT,
an on/off item for a measurement function of a neighboring cell in another RAT than the RAT accessed by the modem,
an item of a measurement period and the number of measurements for the measurement function of the neighboring cell in the another RAT.

5. The AP of claim 3, wherein the AP is further configured to execute the at least one instruction to:
receive wireless communication state information from the modem;
generate a third control signal for functions being executed by the modem after identifying, based on the wireless communication state information, that the communication state of the modem is an out of service state; and
transmit the third control signal to the modem.

6. The AP of claim 5, wherein the third control signal comprises a control signal for at least one of a search period item and a search number item for a cell search function for each neighboring RAT.

7. The AP of claim 1, wherein the location information of the AP comprises at least one of global positioning system (GPS) information, cellular positioning system (CPS) information, and Wi-Fi positioning system (WPS) information.

8. The AP of claim 5, wherein the AP is further configured to execute the at least one instruction to:
acquire remaining battery capacity information of the wireless communication device; and
determine, based on the remaining battery capacity information, whether to generate at least one of the first control signal, the second control signal, and the third control signal.

9. The AP of claim 8, wherein the AP is further configured to execute the at least one instruction not to generate at least one of the first control signal, the second control signal, and the third control signal based on identifying that the remaining battery capacity information is greater than or equal to a threshold value, and
wherein the AP is further configured to execute the at least one instruction to generate at least one of the first control signal, the second control signal, and the third control signal based on identifying that the remaining battery capacity information is less than the threshold value.

10. A modem operatively connected to an application processor (AP), wherein the modem is configured to:
receive, from the AP, at least one control signal among a first control signal, a second control signal, and a third control signal for functions being executed by the modem;
change settings of a target module of the modem corresponding to the at least one control signal; and
transmit a setting completion signal of the target module to the AP, and
wherein the first control signal is received in a first case that the AP is located within a target area,
wherein the second control signal is received in a second case that the AP is moving, and
wherein the third control signal is received in a third case that the communication state of the modem is an out of service state.

11. The modem of claim 10, wherein the first control signal comprises a control signal for at least one of:
an on/off item for a measurement function of a neighboring cell in a same radio access technology (RAT) as a RAT accessed by the modem,
an item of a measurement period and the number of measurements for the measurement function of the neighboring cell in the same RAT,
an on/off item for a measurement function of a neighboring cell in another RAT than the RAT accessed by the modem,
an item of a measurement period and the number of measurements for the measurement function of the neighboring cell in the another RAT,
an on/off item for a cell handover function, an on/off item for a cell reselection function, an item of a decoding period for paging,
an item for controlling signal transmission power,
an item for controlling a feedback value of physical channels, and
an item for controlling a signal reception mode.

12. The modem of claim 10, wherein the second control signal comprises a control signal for at least one of:
an on/off item for a measurement function of a neighboring cell in a same radio access technology (RAT) as a RAT of the accessed by the modem,
an item of a measurement period and the number of measurements for the measurement function of the neighboring cell in the same RAT,
an on/off item for a measurement function of a neighboring cell in another RAT than the RAT accessed by the modem, and
an item of a measurement period and the number of measurements for the measurement function of the neighboring cell in the another RAT.

13. The modem of claim 10, wherein the third control signal comprises a control signal for at least one of a search period item and a search number item for a cell search function for each neighboring RAT.

14. An electronic apparatus comprising:
a control module; and
a communication module,
wherein the control module is configured to:
acquire location information and state information of the electronic apparatus,
generate a control signal for functions being executed by the communication module based on at least one of the location information of the electronic apparatus and the state information of the electronic apparatus, and
transmit the control signal to the communication module, and
wherein the communication module is configured to:
change the setting of a target function corresponding to the control signal based on the transmitted control signal, and
transmit a setting completion signal of the target function to the control module.

15. The electronic apparatus of claim 14, wherein the control module is configured to generate a first control signal for functions executed by the communication module when the electronic apparatus is located within a target area based on the location information of the electronic apparatus, and
wherein the first control signal comprises a control signal for at least one of:
an on/off item for a measurement function of a neighboring cell in a same radio access technology (RAT) as a RAT of the electronic apparatus,
an item of a measurement period and the number of measurements for the measurement function of the neighboring cell in the same RAT,
an on/off item for a measurement function of a neighboring cell in another RAT than the RAT of the electronic apparatus,
an item of a measurement period and the number of measurements for the measurement function of the neighboring cell in the another RAT,
an on/off item for a cell handover function,
an on/off item for a cell reselection function,
an item of a decoding period for paging,
an item for controlling signal transmission power,
an item for controlling a feedback value of physical channels, and
an item for controlling a signal reception mode.

16. The electronic apparatus of claim 14, wherein the control module is further configured to generate a second control signal for functions being executed by the communication module after identifying, based on the location information of the electronic apparatus, that the electronic apparatus is moving.

17. The electronic apparatus of claim 16, wherein the second control signal comprises a control signal for at least one of:
an on/off item for a measurement function of a neighboring cell in a same radio access technology (RAT) as a RAT of the electronic apparatus,
an item of a measurement period and the number of measurements for the measurement function of the neighboring cell in the same RAT,
an on/off item for a measurement function of a neighboring cell in another RAT than the RAT of the electronic apparatus, and
an item of a measurement period and the number of measurements for the measurement function of the neighboring cell in the another RAT.

18. The electronic apparatus of claim 16, wherein the control module is further configured to generate a third control signal for functions being executed by the communication module after identifying, based on wireless communication state information of the electronic apparatus, that the communication state of the electronic apparatus is an out of service state.

19. The electronic apparatus of claim 18, wherein the third control signal comprises a control signal for at least one of a search period item and a search number item for a cell search function for each neighboring radio access technology (RAT) of the electronic apparatus.

20. The electronic apparatus of claim 18, wherein the control module determines whether to transmit at least one of the first control signal, the second control signal, and the third control signal to the communication module, based on remaining battery capacity information among pieces of the state information of the electronic apparatus.
